(19) United States
(12) Patent Application Publication
(10) Pub. No.: US 2009/0214975 A1
(43) Pub. Date: Aug. 27, 2009

(54) TONER FOR DEVELOPING ELECTROSTATIC LATENT IMAGE AND METHOD OF PREPARING THE TONER, AND IMAGE FORMING METHOD USING THE TONER

(76) Inventors: Junichi AWAMURA, Numazu-shi (JP); Akinori Saitoh, Numazu-shi (JP); Osamu Uchinokura, Mishima-shi (JP); Masahide Yamada, Numazu-shi (JP); Tomomi Suzuki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/370,000

(22) Filed: Feb. 12, 2009

(30) Foreign Application Priority Data
Feb. 27, 2008 (JP) 2008-045704

(51) Int. Cl. G03G 9/16

(52) U.S. Cl. 430/113

(57) ABSTRACT

A toner prepared by a method including dissolving or dispersing at least at least one member selected from the group consisting of binder resins and precursors thereof, a colorant, a release agent, and a layered inorganic mineral in which ions between its layers are at least partially modified with an organic ion in an organic solvent to prepare a solution or a dispersion which is an oil phase; and dispersing the oil phase in an aqueous medium to prepare an emulsified dispersion in which parent toner particles are granulated, wherein the aqueous medium includes a tertiary amine compound.

### BACKGROUND OF THE INVENTION

1. Field of the Invention

The present invention relates to a toner for use in a developer developing an electrostatic latent image in electrophotographies, electrostatic recording and electrostatic printing, and to a method of producing the toner and an image forming method and an apparatus using the toner. More specifically to a toner for use in copiers, laser printers and plain paper facsimiles using direct or indirect electrophotographic developing methods, and to a method of producing the toner and an image forming method and an apparatus using the toner.

2. Discussion of the Background

Due to recent strong demands for high-quality images, developments of an electrophotographic apparatus and a toner developer in compliance with the demand are accelerated. It is essential that the toner particles have a uniform diameter for the high-quality image. When the particle diameter distribution is sharp, individual toner particles uniformly work to remarkably improve reproducibility of a micro dot image.

However, toner particles having a small and uniform diameter has less cleanability. In particular, it is impossible to stably clean the toner particles having a small and uniform diameter with a cleaning blade. One of methods of improving the cleanability suggested is to change the toner particles from spheric particles to irregular-shaped particles. The irregular-shaped toner particles have less fluidity and the cleaning blade can easily catch the toner particles. However, toner particles being too irregular-shaped do not stably work in developing and have less micro dot reproducibility.

As mentioned above, the irregular-shaped toner particles have improved cleanability, but have deteriorated fixability. Namely, the irregular-shaped toner particles has less density in a toner layer on a transfer material before fixed and a conduction in the toner layer is deteriorated when fixed, resulting in deterioration of the low-temperature fixability. In particular, when a fixing pressure is smaller than usual, the conduction is further deteriorated.

Japanese published unexamined application No. 11-133665 discloses a toner including polyester having a Wadell practical sphericity of from 0.90 to 1.00. However, the toner is substantially spheric and does not solve the above-mentioned cleanability problem.

Toner polymerization methods include an emulsifying polymerization method and a dissolving suspension method, which easily produce the irregular-shaped toner particles other than a suspension polymerization method. However, it is also difficult to completely remove the styrene monomer, an emulsifier and a dispersant in the emulsifying polymerization method, which is becoming a more serious problem recently when an environmental protection is particularly emphasized. In addition, a silica included in the toner as a fluidizer does not strongly adhere to a concave portion thereof and moves thereto, which often causes problems such as photoreceptor contamination and adherence to a fixing roller due to a release of the silica when the developer is used for a long time. In the dissolving suspension method, there is an advantage of using a polyester resin capable of fixing at a low temperature, but productivity deteriorates because a high molecular weight material is controlled to increase releasability in an oilless fixation and a solvent has a high viscosity as the high molecular weight material is included in a process of dissolving or dispersing a resin or a colorant in the solvent. These problems are not solved yet. Particularly, in the dissolving suspension method, Japanese published unexamined application No. 9-15903 discloses a toner having a shape of both sphere and concavity and convexity to improve the cleanability, but the amorphous toner without uniformity has low chargeability and a design of a high molecular weight material is not completed yet to obtain basic durability and releasability, and therefore quality of the toner is still unsatisfactory.

A charge controlling agent is frequently used to control charging a toner. In pulverization methods including melting and kneading a thermoplastic resin as a binder resin, a colorant and an optional additive to prepare a kneaded mixture; and pulverizing and classifying the kneaded mixture to prepare a toner, (1) there is a limit of downsizing the particle diameter of a toner to produce images having higher quality, (2) the materials can uniformly be dispersed in particles, but placements thereof in particles are uncontrollable, and (3) too many charge controlling agents cause filming and poor fixability.

Lately, modified layered inorganic minerals, a part of the ions present between the layers of which is modified with an organic ion, are used as charge controlling agents as disclosed in International Publications Nos. WO01/040878, WO2004/007423, WO2004/019138 and Japanese published unexamined application No. 2003-202708. These also have the above-mentioned problem.

Because of these reasons, a need exists for an oilless dry toner having good transferability and stable chargeability without filming.

### SUMMARY OF THE INVENTION

Accordingly, an object of the present invention is to provide an oilless dry toner having good transferability and stable chargeability without filming.

An other object of the present invention is to provide a developer including the toner.

A further object of the present invention is to provide an image forming apparatus using the toner.

An other object of the present invention is to provide an image forming method using the toner.

A further object of the present invention is to provide a method of preparing the toner.

These objects and other objects of the present invention, either individually or collectively, have been satisfied by the discovery of a toner prepared by a method comprising:

dissolving or dispersing at least:
at least one member selected from the group consisting of binder resins and precursors thereof,
a colorant,
a release agent, and
a layered inorganic mineral in which ions between its layers are at least partially modified with an organic ion in an organic solvent to prepare a solution or a dispersion which is an oil phase; and

dispersing the oil phase in an aqueous medium to prepare an emulsified dispersion in which parent toner particles are granulated,

wherein the aqueous medium comprises a tertiary amine compound.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is across-sectional view illustrating an embodiment of the image forming apparatus of the present invention; and

FIG. 2 is a partially-amplified view of the image forming apparatus in FIG. 1.

### DETAILED DESCRIPTION OF THE INVENTION

The present invention provides an oilless dry toner having good transferability and stable chargeability without filming.

More particularly, the present invention relates to a toner prepared by a method comprising:

dissolving or dispersing at least:
at least one member selected from the group consisting of binder resins and precursors thereof,
a colorant,
a release agent, and
a layered inorganic mineral in which ions between its layers are at least partially modified with an organic ion in an organic solvent to prepare a solution or a dispersion which is an oil phase; and

dispersing the oil phase in an aqueous medium to prepare an emulsified dispersion in which parent toner particles are granulated,

wherein the aqueous medium comprises a tertiary amine compound.

While parent toner particles are granulated in an O/W emulsion, although the layered inorganic mineral is hydrophobic, the affinity thereof to the aqueous phase and the oil phase is thought to vary due to ions between its layers and the exchange quantity thereof (the affinity thereof also varies due to the polarity of the oil phase).

The present invention enables local presence near the surface of the parent toner particles by modifying with the organic ions between the layers such that the local presence is preferably made near the surface of a particulate oil droplet which is a base of the parent toner particles when granulating them from an oil phase in an aqueous medium. Namely, the modified layered inorganic mineral transfers to the surface of the oil droplet and is likely to be locally present at the surface of the parent toner particles. When modified less with the organic ions, the hydrophobicity of the layered inorganic mineral is insufficient and the inter layer peeling is difficult, resulting in insufficient dispersion thereof in a toner and insufficient observation as Al at the surface of a toner.

When modified more with the organic ions, the ions are changed or surface-treated to increase the hydrophobicity, the layered inorganic mineral is uniformly dispersed in parent toner particles and locally present at the center thereof.

Typically, a charge controlling agent on the surface of a toner is thought to largely increase the chargeability thereof, and a toner having many of the modified layered inorganic mineral on its surface has sufficient chargeability in fact.

In another respect, a pulverization toner prepared by kneading and pulverizing includes an additive uniformly dispersed when kneaded, and the additive is hardly present at the surface locally. Therefore, the pulverization toner has a disadvantage in chargeability, compared with the above-mentioned toner capable of locally having a layered inorganic mineral at its surface. When a charge controlling agent is increased to improve chargeability of the pulverization toner, the fixability and spent resistance thereof deteriorates as an adverse effect.

In addition, even a small amount of the modified layered inorganic mineral fulfills its function because it can be surface-directed in an O/W emulsion. This can minimize the influence on the fixability and can make the particle diameter smaller because of granulating in an aqueous medium. Further, the modified layered inorganic mineral can be fully dispersed in a liquid (solvent).

In the present invention, toner constituents are preferably dissolved or dispersed in a solvent. The solvent preferably includes an organic solvent. The organic solvent is preferably removed when or after granulating parent toner particles.

The organic solvent preferably has a boiling point lower than 150° C. because they are easy to remove. Specific examples of the solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. Among these solvents, aromatic solvents such as toluene and xylene; and halogenated hydrocarbons such as methylene chloride, 1,2-dichloroethane, chloroform, and carbon tetrachloride are preferably used. Particularly, ethyl acetate is more preferably used. These solvents can be used alone or in combination.

The content of the solvent is preferably from 40 to 300 parts by weight, more preferably from 60 to 140 parts by weight, and furthermore preferably from 80 to 120 parts by weight, per 100 parts by weight of the toner constituents.

The toner constituents includes materials other than a binder resin, a colorant and a modified layered inorganic mineral in which metallic cations are at least partially modified with organic cations if desired. The toner typically includes a monomer, a polymer, a compound having an active hydrogen or a polymer reactive with an active hydrogen as a binder resin and other components such as a release agent if desired.

The modified layered inorganic mineral for use in the present invention will be explained.

The layered inorganic mineral is an inorganic mineral including overlapped layers having a thickness of some nm respectively. Modifying with an organic material ion means introducing an organic material ion into an ion present between the layers, which is called an intercalation in a broad sense like a lithium battery including lithium ions between its polyaniline layers and specifically disclosed in International Publications Nos. WO2004/007423 and WO2004/019138, and Japanese published unexamined patent application No. 2003-202708. The layered inorganic minerals include a smectite group such as montmorillonite and saponite; a kaolin group such as kaolinite; magadiite; and kanemite. The modified layered inorganic mineral has high hydrophilicity because of its modified layered structure. Therefore, when the layered inorganic mineral is dispersed without being modified in an aqueous medium to granulate a toner, the layered inorganic mineral passes into the aqueous medium and cannot be dispersed in a toner. The layered inorganic mineral becomes more hydrophobic when modified and is easily dispersed and miniaturized in a toner when granulated to fully perform charge controllability. Particularly, the layered inorganic mineral is much present at the surface of a toner and improves low-temperature fixability as well as charge controllability thereof. However, the surface concavities and convexities of a deformed toner deteriorate transferability thereof.

In order to solve this problem, it is essential to include a tertiary amine compound in an aqueous medium when emulsion dispersing an oil phase therein in the present invention. The tertiary amine compound decreases concavities and convexities on the surface of a toner to prevent deformation thereof, and the resultant toner has good transferability and chargeability. The toner constituents preferably include the modified layered inorganic mineral in an amount of from 0.1 to 5% by weight.

In the present invention, the aqueous medium preferably has a pH of from 6.5 to 8.0. When less than 6.5, the resultant toner possibly has a concave and convex surface and poor transferability. When higher than 8.0, the resultant toner doe not have good chargeability and it is possibly difficult to granulate a toner. The aqueous medium preferably includes a tertiary amine compound as well to control its pH.

The modified layered inorganic mineral for use in the present invention is preferably a mineral having a basic smectite crystal structure, which is modified with an organic cation. A part of the bivalent metal of the layered inorganic mineral can be substituted with a trivalent metal to form a metal anion. However, the metal anion has high hydrophilicity and a part thereof is preferably modified with an organic anion.

The organic material ion modifier includes a quaternary alkyl ammonium salt, a phosphonium salt, an imidazolium salt, etc., and the quaternary alkyl ammonium salt is preferably used. Specific examples thereof include trimethylstearylammonium, dimethylstearylbenzylammonium, dimethyloctadecylammonium, oleylbis(2-hydroxylethyl)methylammonium, etc.

The organic material ion modifier further includes sulfate salts having a branched, unbranched or cyclic alkyl group having 1 to 44 carbon atoms, an alkenyl group having 1 to 22 carbon atoms, an alkoxy group having 8 to 32 carbon atoms, a hydroxyalkyl group having 2b to 22 carbon atoms, an ethylene oxide, a propylene oxide, etc.; salts of sulfonic acid; salts of carboxylic acid; or salts of phosphoric acid. A carboxylic acid having an ethylene oxide skeleton is preferably used.

The (modified) layered inorganic mineral partially modified with an organic material ion has appropriate hydrophobicity, and an oil phase including toner constituents and/or a toner constituents precursor has a non-Newtonian viscosity and the resultant toner can be deformed. The toner constituents preferably include the layered inorganic mineral partially modified with an organic material ion in an amount of from 0.1 to 5% by weight. When less than 0.1% by weight, the effect to chargeability of a toner lowers. When greater than 5% by weight, the resultant toner deteriorates in fixability.

Specific examples of the (modified) layered inorganic mineral partially modified with an organic material ion include montmorillonite, bentonite, hectolite, attapulgite, sepiolite, their mixtures, etc. Particularly, the organic-modified montmorillonite and bentonite are preferably used because they do not influence upon the resultant toner properties, the viscosity thereof can easily be controlled and a small content thereof works.

Specific examples of marketed products of the layered inorganic mineral partially modified with an organic material cation include Quartanium 18 Bentonite such as Bentone 3, Bentone 38, Bentone 38V, Tixogel VP, Clayton 34, Clayton 40 and Clayton XL; Stearalkonium Bentonite such as Bentone 27, Tixogel LG, Clayton AF and Clayton APA; and Quartanium 18/Benzalkonium Bentonite such as Clayton HT and Clayton PS. Particularly, Clayton AF and Clayton APA are preferably used. In addition, DHT-4A from Kyowa Chemical Industry, Co., Ltd., which is modified with an organic anion having the following formula (1) is preferably used as the layered inorganic mineral partially modified with an organic anion. Specific examples of the organic anion having the following formula (1) include Hitenol 3330T from Dai-ichi Kogyo Seiyaku Co., Ltd.

R₁(OR₂)ₙOSO₃M (1)w

wherein R1 represents an alkyl group having 13 carbon atoms; R₂ represents an alkylene group having 2 to 6 carbon atoms; n represents an integer of from 2 to 10; and M represents a monovalent metallic element.

The modified layered inorganic mineral has appropriate hydrophobicity, and is likely to be locally present at the surface of a droplet and the resultant toner has good chargeability.

The toner of the present invention preferably has a ratio (Dv/Dn) of a volume-average particle diameter (Dv) thereof to a number-average particle diameter thereof (Dn) of from 1.10 to 1.30 to produce high-resolution and high-quality images. Further, in a two-component developer, the toner has less variation in the particle diameter even after consumed and fed for long periods, and has good and stable developability even after stirred in an image developer for long periods. When Dv/Dn is greater than 1.30, the particle diameter distribution of the toner becomes flat, resulting in deterioration of reproducibility of a microscopic dot. The toner more preferably has Dv/Dn of from 1.00 to 1.20 to produce better quality images.

The toner of the present invention preferably has a volume-average particle diameter (Dv) of from 3.0 to 7.0 μm. Typically, it is said that the smaller the toner particle diameter, the more advantageous to produce high resolution and quality images. However, the small particle diameter of the toner is disadvantageous thereto to have transferability and cleanability. When the volume-average particle diameter is too small, the resultant toner in a two-component developer melts and adheres to a surface of a carrier to deteriorate chargeability thereof when stirred for long periods in an image developer. When the toner is used in a one-component developer, toner filming over a developing roller and fusion bond of the toner to a blade forming a thin layer thereof tend to occur. This largely depends on a content of a fine powder. When the toner includes particles having a diameter not greater than 2 μm in an amount greater than 20% by number, the toner is likely to adhere to a carrier and have poor charge stability. When the average particle diameter is larger than the scope of the present invention, the resultant toner has a difficulty in producing high resolution and quality images. In addition, the resultant toner has a large variation of the particle diameters in many cases after the toner in a developer is consumed and fed for long periods. When Dv/Dn is greater than 1.30, the results are same.

The toner of the present invention preferably has an average circularity of from 0.96 to 0.99. When less than 0.96, the toner deteriorates in transferability. This is because the toner is too deformed (has too large concavities and convexities on its surface) to smoothly transfer from the surface of a photoreceptor to a transfer paper or an intermediate transferer, or from a first intermediate transferer to a second intermediate transferer, etc. Further, the toners do not uniformly move, therefore do not have uniform and high transferability. Besides, the toner is fragile and not stably charged. Further, the toner is micronized in a developer, which causes the developer to have low durability.

The content of the toner particles having a diameter not greater than 2 μm and the circularity of the toner is measured by a flow-type particle image analyzer FPIA-2000 from SYSMEX CORPORATION. A specific measuring method includes adding 0.1 to 0.5 ml of a surfactant, preferably an alkylbenzenesulfonic acid, as a dispersant in 100 to 150 ml of water from which impure solid materials are previously removed; adding 0.1 to 0.5 g of the toner in the mixture; dispersing the mixture including the toner with an ultrasonic disperser for 1 to 3 min to prepare a dispersion liquid having a concentration of from 3,000 to 10,000 pieces/μl; and measuring the toner shape and distribution with the above-mentioned measurer.

The average particle diameter and particle diameter distribution of the toner can be measured by a Coulter counter TA-II or Coulter Multisizer II from Beckman Coulter, Inc. as follows:

0.1 to 5 ml of a detergent, preferably alkylbenzene sulfonate is included as a dispersant in 100 to 150 ml of the electrolyte ISOTON R-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

In the present invention, an Interface producing a number distribution and a volume distribution from Nikkaki Bios Co., Ltd. and a personal computer PC9801 from NEC Corp. are connected with the Coulter Multisizer II to measure the average particle diameter and particle diameter distribution.

Further in the present invention, the binder resin preferably includes a polyester resin in an amount of from 50 to 100% by weight to prepare a toner maintaining heat-resistant preservability, effectively exerting low-temperature fixability and having offset resistance. The binder resin preferably has an acid value of from 1.0 to 50.0 KOH mg/g. THF-soluble components of the polyester resin preferably have a weight-average molecular weight of from 1,000 to 30,000. When less than 1,000, the heat-resistant preservability deteriorates because an oligomer components increase. When greater than 30,000, the offset resistance deteriorates because the polyester resin is not sufficiently modified due to a steric hindrance.

In the present invention, molecular weight is measured by GPC (gel permeation chromatography) as follows. A column is stabilized in a heat chamber having a temperature of 40° C.; THF is put into the column at a speed of 1 ml/min as a solvent; 50 to 200 μl of a THF liquid-solution of a resin, having a sample concentration of from 0.05 to 0.6% by weight, is put into the column; and a molecular weight distribution of the sample is determined by using a calibration curve which is previously prepared using several polystyrene standard samples having a single distribution peak, and which shows the relationship between a count number and the molecular weight. As the standard polystyrene samples for making the calibration curve, for example, the samples having a molecular weight of 6×10², 2.1×10³, 4×10³, 1.75×10⁴, 5.1×10⁴, 1.1×10⁵, 3.9×10⁵, 8.6×10⁵, 2×10⁶ and 48×10⁶ from Pressure Chemical Co. or Tosoh Corporation are used. It is preferable to use at least 10 standard polystyrene samples. In addition, an RI (refraction index) detector is used as the detector.

When the binder resin has an acid value of from 1.0 to 50.0 KOH mg/g, a basic compound is capably added to the toner to enhance the toner properties such as particle diameter controllability, low-temperature fixability, hot offset resistance, heat-resistant preservability and charge stability. Namely, when the acid value is greater than 50.0 KOH mg/g, an elongation or a cross-linking reaction of the binder resin precursor insufficiently performed, resulting in poor hot offset resistance. When less than 1.0 KOH mg/g, a basic compound does not stabilize the dispersion of the binder resin and an elongation or a cross-linking reaction of a modified polyester is likely to perform, i.e., the toner is not stably prepared.

The acid value of the polyester resin for use in the present invention is measured by the following method based on JIS K0070, using a mixed a solvent including 120 ml of toluene and 30 ml of ethanol.

The acid value is specifically decided by the following procedure.

| | |
|---|---|
| Measurer: | potentiometric automatic titrator |
| | DL-53 Titrator from Metler-Toledo |
| | Limited |
| Electrode: | DG113-SC from Metler-Toledo Limited |
| Analysis software: | LabX Light Version 1.00.000 |
| Temperature: | 23° C. |

The measurement conditions are as follows:

Stir

| | |
|---|---|
| Speed [%] | 25 |
| Time [s] | 15 |

EQP titration
Titrant/Sensot

| | |
|---|---|
| Titrant | CH30Na |
| Concentration [mol/L] | 0.1 |
| Sensor | DG115 |
| Unit of measurement | mV |

Predispensing to volume

| | |
|---|---|
| Volume [ml] | 1.0 |
| Wait time [s] | 0 |

| | |
|---|---|
| Titrant addition | Dynamic |
| dE (set) [mV] | 8.0 |
| dV (min) [mL] | 0.03 |
| dV (max) [mL] | 0.5 |

| | |
|---|---|
| Measure mode | Equilibrium controlled |
| dE [mV] | 0.5 |
| dt [s] | 1.0 |
| t (min) [s] | 2.0 |
| t (max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. Termination conditions | No |
| | Evaluation |

Procedure Standard

| | |
|---|---|
| Potential 1 | No |
| Potential 2 | No |
| Step for reevaluation | No |

The acid value of the resin is measured by the method mentioned in JIS K0070-1992.

0.5 g of polyester is stirred in 120 ml of THF at a room temperature (23° C.) for 10 hrs to be dissolved therein, and 30 ml of ethanol is further added thereto to prepare a sample solution.

The following device is used to measure the acid value, and which is specifically determined as follows.

A N/10 caustic potassium-alcohol solution is titrated in the sample solution and the acid value is determined form a consumed amount of the caustic potassium-alcohol solution using the following formula:

Acid value=KOH(ml)×N×56.1/weight of the sample solution wherein N is N/10 KOH factor.

In the present invention, heat-resistant preservability of main components of a polyester resin after modified, i.e., a binder resin depends on a glass transition temperature of the polyester resin before modified, and the polyester resin preferably has a glass transition temperature of from 35 to 65° C. When less than 35° C., the heat-resistant preservability is insufficient. When greater than 65° C., the low-temperature fixability deteriorates.

In the present invention, the glass transition temperature (Tg) is measured by TG-DSC system TAS-100 from RIGAKU Corp. at a programming rate of 10° C./min.

First, about 10 mg of a sample in an aluminum container was loaded on a holder unit, which was set in an electric oven. After the sample was heated in the oven at from a room temperature to 150° C. and a programming speed of 10° C./min, the sample was left for 10 min at 150° C. After the samples was cooled to have a room temperature and left for 10 min, the sample was heated again in a nitrogen environment to have a temperature of 150° C. at a programming speed of 10° C./min and DSC measurement of the sample was performed. Tg was determined from a contact point between a tangent of a heat absorption curve close to Tg and base line using an analyzer in TAS-100.

In the present invention, a prepolymer (a binder resin precursor having a site reactable with an active hydrogen group) modifying a polyester resin (one of binder reins) is essential to realize low-temperature fixability and hot offset resistance of the resultant toner, and preferably has a weight-average molecular weight of from 3,000 to 20,000. When less than 3,000, the reaction speed is difficult to control and the production stability deteriorates. When greater than 20,000, a polyester sufficiently modified cannot be obtained and offset resistance of the resultant toner deteriorates.

In the present invention, an acid value of a toner is more essential index than that of a binder resin for low-temperature fixability and hot offset resistance of the resultant toner. An acid value of the toner of the present invention comes from an end carboxyl group of an unmodified polyester resin. The toner preferably has an acid value of form 0.5 to 40.0 (KOH mg/g) to control low-temperature fixability such as minimum fixable temperature and hot offset generation temperature of the resultant toner. When greater than 40.0 (mg KOH/g), an elongation or a cross-linking reaction of a modified polyester is not sufficient and the hot offset resistance of the resultant toner deteriorates. When less than 0.5 (mg KOH/g), a basic compound does not stabilize the dispersion of the binder resin and an elongation or a cross-linking reaction of a modified polyester is likely to perform, i.e., the toner is not stably prepared. The acid value of a toner is measured according to JIS K0070.

The toner of the present invention preferably has a glass transition temperature of from 40 to 70° C. to have low-temperature fixability, high-temperature offset resistance and high durability. When less than 40° C., toner blocking in an image developer and filming over a photoreceptor tend to occur. When greater than 70° C., the low-temperature fixability of the resultant toner deteriorates.

The toner of the present invention is preferably prepared by dissolving or dispersing toner constituents including at least binder components including a modified polyester resin reactable with an active hydrogen, a colorant, a release agent and a modified layered inorganic mineral in an organic solvent to prepare a solution or a dispersion (an oil phase in an organic solvent); reacting the dispersion with a crosslinker and/or an elongator (while and/or after) dispersing the solution or dispersion in an aqueous medium including a tertiary amine compound to prepare a dispersion; and removing the organic solvent from the dispersion.

Specific examples of the modified polyester resin reactable with an active hydrogen include a polyester prepolymer (A) having an isocyanate group. Specific examples of the prepolymer (A) include a polymer formed from a reaction between polyester having an active hydrogen atom formed by polycondensation between polyol (PO) and a polycarboxylic acid, and polyisocyanate (PIC). Specific examples of the groups including the active hydrogen include a hydroxyl group (an alcoholic hydroxyl group and a phenolic hydroxyl group), an amino group, a carboxyl group, a mercapto group, etc. In particular, the alcoholic hydroxyl group is preferably used.

Amines are used as a crosslinker for the reactive modified polyester resin, and diisocyanate compounds such as diphenylmethanediisocyanate are used as an elongator therefor. The amines mentioned in detail later work as a crosslinker or an elongator for the modified polyester resin reactable with an active hydrogen.

The modified polyester such as a urea-modified polyester formed from a reaction between the polyester prepolymer having an isocyanate group (A) and an amine (B) is easy to control molecular weight of the high molecular weight component, and preferably used for an oilless low-temperature fixing method (without an release oil applicator for a heating medium for fixation). Particularly, the polyester prepolymer having a urea-modified end can prevent adherence to the heating medium for fixation while maintaining high fluidity and transparency of an unmodified polyester resin in a range of fixing temperature.

The polyester prepolymer for use in the present invention is preferably a polyester having at its end an acid radical or a hydroxyl group including an active hydrogen to which a functional group such as an isocyanate group is introduced. A modified polyester such as a urea-modified polyester can be introduced from the prepolymer. However, in the present invention, the modified polyester used as a toner binder is preferably a urea-modified polyester formed from a reaction between the polyester prepolymer having an isocyanate group (A) and the amine (B) used as a crosslinker and/or an elongation agent. The polyester prepolymer (A) can be formed from a reaction between polyester having an active hydrogen atom formed by polycondensation between polyol (PO) and a polycarboxylic acid, and polyisocyanate (PIC). Specific examples of the groups including the active hydrogen include a hydroxyl group (an alcoholic hydroxyl group and a phenolic hydroxyl group), an amino group, a carboxyl group, a mercapto group, etc. In particular, the alcoholic hydroxyl group is preferably used.

As the polyol (PO), diol (DIO) and polyol having 3 valences or more (TO) can be used, and DIO alone or a mixture of DIO and a small amount of TO is preferably used. Specific examples of DIO include alkylene glycol such as ethylene glycol, 1,2-propylene glycol, 1,3-propylene glycol, 1,4-butanediol, and 1,6-hexanediol; alkylene ether glycol such as diethylene glycol, triethylene glycol, dipropylene glycol, polyethylene glycol, polypropylene glycol and polytetramethylene ether glycol; alicyclic diol such as 1,4-cyclohexanedimethanol and hydrogenated bisphenol A; bisphenol such as bisphenol A, bisphenol F and bisphenol S; adducts of the above-mentioned alicyclic diol with an alkylene oxide such as ethylene oxide, propylene oxide and butylene oxide; and adducts of the above-mentioned bisphenol with an alkylene oxide such as ethylene oxide, propylene oxide and butylene oxide. In particular, alkylene glycol having 2 to 12 carbon atoms and adducts of bisphenol with an alkylene oxide are preferably used, and a mixture thereof is more preferably used. Specific examples of TO include multivalent aliphatic alcohol having 3 to 8 or more valences such as glycerin, trimethylolethane, trimethylolpropane, pentaerythritol and sorbitol; phenol having 3 or more valences such as trisphenol PA, phenolnovolak, cresolnovolak; and adducts of the above-mentioned polyphenol having 3 or more valences with an alkylene oxide.

As the polycarboxylic acid (PC), dicarboxylic acid (DIC) and polycarboxylic acid having 3 or more valences (TC) can be used. DIC alone, or a mixture of DIC and a small amount of TC are preferably used. Specific examples of DIC include alkylene dicarboxylic acids such as succinic acid, adipic acid and sebacic acid; alkenylene dicarboxylic acid such as maleic acid and fumaric acid; and aromatic dicarboxylic acids such as phthalic acid, isophthalic acid, terephthalic acid and naphthalene dicarboxylic acid. In particular, alkenylene dicarboxylic acid having 4 to 20 carbon atoms and aromatic dicarboxylic acid having 8 to 20 carbon atoms are preferably used. Specific examples of TC include aromatic polycarboxylic acids having 9 to 20 carbon atoms such as trimellitic acid and pyromellitic acid. PC can be formed from a reaction between the PO and the above-mentioned acids anhydride or lower alkyl ester such as methyl ester, ethyl ester and isopropyl ester. PO and PC are mixed such that an equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

Specific examples of the PIC include aliphatic polyisocyanate such as tetramethylenediisocyanate, hexamethylenediisocyanate and 2,6-diisocyanatemethylcaproate; alicyclicpolyisocyanate such as isophoronediisocyanate and cyclohexylmethanediisocyanate; aromatic diisocyanate such as tolylenedisocyanate and diphenylmethanediisocyanate; aroma aliphatic diisocyanate such as α, α, α′, α′-tetramethylxylylenediisocyanate; isocyanurate; the above-mentioned polyisocyanate blocked with phenol derivatives, oxime and caprolactam; and their combinations.

The PIC is mixed with polyester such that an equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1. When [NCO]/[OH] is greater than 5, low temperature fixability of the resultant toner deteriorates. When [NCO] has a molar ratio less than 1, a urea content in ester of the modified polyester decreases and hot offset resistance of the resultant toner deteriorates. The content of the constitutional component of a polyisocyanate in the polyester prepolymer (A) having a polyisocyanate group at its end portion is from 0.5 to 40% by weight, preferably from 1 to 30% by weight and more preferably from 2 to 20% by weight. When the content is less than 0.5% by weight, hot offset resistance of the resultant toner deteriorates, and in addition, the heat resistance and low temperature fixability of the toner also deteriorate. In contrast, when the content is greater than 40% by weight, low-temperature fixability of the resultant toner deteriorates.

The number of the isocyanate groups included in a molecule of the polyester prepolymer (A) is at least 1, preferably from 1.5 to 3 on average, and more preferably from 1.8 to 2.5 on average. When the number of the isocyanate group is less than 1 per 1 molecule, the molecular weight of the urea-modified polyester decreases and hot offset resistance of the resultant toner deteriorates.

Specific examples of the amines (B) include diamines (B1), polyamines (B2) having three or more amino groups, amino alcohols (B3), aminomercaptans (B4), aminoacids (B5) and blocked amines (B6) in which the amines (B1-B5) mentioned above are blocked. Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoronediamine); aliphatic diamines (e.g., ethylene diamine, tetramethylene diamine and hexamethylene diamine); etc. Specific examples of the polyamines (B2) having three or more amino groups include diethylene triamine, triethylene tetramine. Specific examples of the amino alcohols (B3) include ethanol amine and hydroxyethyl aniline. Specific examples of the amino mercaptan (B4) include aminoethyl mercaptan and aminopropyl mercaptan. Specific examples of the amino acids include amino propionic acid and amino caproic acid. Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc. Among these compounds, diamines (B1) and mixtures in which a diamine is mixed with a small amount of a polyamine (B2) are preferably used.

The molecular weight of the urea-modified polyesters can optionally be controlled using an elongation anticatalyst, if desired. Specific examples of the elongation anticatalyst include monoamines such as diethyle amine, dibutyl amine, butyl amine and lauryl amine, and blocked amines, i.e., ketimine compounds prepared by blocking the monoamines mentioned above.

The mixing ratio (i.e., a ratio [NCO]/[NHx]) of the content of the prepolymer (A) having an isocyanate group to the amine (B) is from 1/2 to 2/1, preferably from 1.5/1 to 1/1.5 and more preferably from 1.2/1 to 1/1.2. When the mixing ratio is greater than 2 or less than 1/2, molecular weight of the urea-modified polyester decreases, resulting in deterioration of hot offset resistance of the resultant toner.

In the present invention, as a catalyst and a reducer of the surface concavities and convexities of a toner, tertiary amine compounds are used. Specific examples of the tertiary amine compounds include amine, amino alcohol, amino mercaptan and amidine. Specific examples of the amine include aromatic amine such as triphenyl amine and triallyl amine; and aliphatic amine such as triethyl amine and trimethyl amine. Specific examples of the amino alcohol include triethanol amine, dihydroxyethylaniline, etc. Specific examples of the amino mercaptan include triethanethiol amine, trimethanethiol amine, etc. Specific examples of the amidine include DBU (1,8-diaza-bicyclo[5.4.0]undecen-7), DBN (1,5-diaza-bicyclo[4.3.0]nonen-5), etc. Among these tertiary amine compounds, a compound having the following formula (I) is more preferably used.

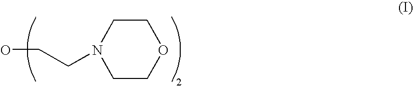

A polyester resin preferably used in the present invention is a urea-modified polyester (UMPE), and the UMPE may include an urethane bonding as well as a urea bonding. The molar ratio (urea/urethane) of the urea bonding to the urethane bonding is from 100/0 to 10/90, preferably from 80/20 to 20/80 and more preferably from 60/40 to 30/70. When the content of the urea bonding is less than 10%, hot offset resistance of the resultant toner deteriorates.

The modified polyester such as the UMPE can be produced by a method such as a one-shot method. The weight-average molecular weight of the modified polyester of the UMPE is not less than 10,000, preferably from 20,000 to 10,000,000 and more preferably from 30,000 to 1,000,000. When the weight-average molecular weight is less than 10,000, hot offset resistance of the resultant toner deteriorates. The number-average molecular weight of the modified polyester of the UMPE is not particularly limited when the after-mentioned an unmodified polyester resin (PE) is used in combination. Namely, the weight-average molecular weight of the UMPE resins has priority over the number-average molecular weight thereof. However, when the UMPE is used alone, the number-average molecular weight is from 2,000 to 15,000, preferably from 2,000 to 10,000 and more preferably from 2,000 to 8,000. When the number-average molecular weight is greater than 20,000, the low temperature fixability of the resultant toner deteriorates, and in addition the glossiness of full-color images deteriorates.

In the present invention, not only the modified polyester of the UMPE alone but also the PE can be included as a toner binder with the UMPE. A combination thereof improves low temperature fixability of the resultant toner and glossiness of color images produced thereby, and the combination is more preferably used than using the UMPE alone. Suitable PE includes polycondensation products of PO and PC similarly to the UMPE and specific examples of the PE are the same as those of the UMPE. The PE preferably has a weight-average particle diameter (Mw) of from 10,000 to 300,000, and more preferably from 14,000 to 200,000. In addition, the PE preferably has a number-average particle diameter of from 1,000 to 10,000, and more preferably from 1,500 to 6,000. In addition, for the UMPE, not only the unmodified polyester but also polyester resins modified by a bonding such as urethane bonding other than a urea bonding, can also be used together. It is preferable that the UMPE at least partially mixes with the PE to improve the low temperature fixability and hot offset resistance of the resultant toner. Therefore, the UMPE preferably has a structure similar to that of the PE. A mixing ratio (UMPE/PE) between the UMPE and PE is from 5/95 to 80/20, preferably from 5/95 to 30/70, more preferably from 5/95 to 25/75, and even more preferably from 7/93 to 20/80. When the UMPE is less than 5%, the hot offset resistance deteriorates, and in addition, it is disadvantageous to have both high-temperature preservability and low-temperature fixability.

The PE preferably has a hydroxyl value not less than 5 mg KOH/g and an acid value of from 1 to 30 mg KOH/g, and more preferably from 5 to 20 mg KOH/g. Such PE tends to be negatively charged, and the resultant toner has good affinity with a paper and low temperature fixability thereof is improved. However, when the acid value is greater than 30 mg KOH/g, chargeability of the resultant toner deteriorates particularly due to an environmental variation. In a polyaddition reaction, a variation of the acid value causes a crush of particles in a granulation process and it is difficult to control emulsifying.

The hydroxyl value is measured similarly to the method of measuring the acid value.

Precisely-weighed 0.5 g of a sample is placed in a volumetric flask, and precisely-measured 5 ml of an acetylated reagent is added thereto to prepare a mixture. The mixture is heated whiled dipped in an oil bath having a temperature at 100±5° C. One to two hrs later, the flask is taken out of the oil bath and left to cool. Water is added to the mixture, and the mixture is shaken to breakdown an acetic anhydride. The flask is heated again in an oil bath to complete the breakdown for not less than 10 min. After left and cooled, the inner wall of the flask is washed with an organic solvent. The mixture is subjected to a potentiometric titration with a N/2 potassium hydroxide ethyl alcohol solution using the above-mentioned electrode according to JIS K0070-1966.

In the present invention, the toner binder preferably has a glass transition temperature (Tg) of from 40 to 70° C., and preferably from 40 to 60° C. When the glass transition temperature is less than 40° C., the heat resistance of the toner deteriorates. When higher than 70° C., the low temperature fixability deteriorates. Because of a combination of the modified polyester such as UMPE and PE, the toner of the present invention has better heat-resistant preservability than known toners including a polyester resin as a binder resin even though the glass transition temperature is low.

The wax for use in the toner of the present invention has a low melting point of from 50 to 120° C. When such a wax is included in the toner, the wax is dispersed in the binder resin and serves as a release agent at a location between a fixing roller and the toner particles. Thereby, hot offset resistance can be improved without applying an oil to the fixing roller used.

In the present invention, the melting point of the wax is a maximum heat absorption peak measured by a differential scanning calorimeter (DSC).

Specific examples of the release agent include natural waxes such as vegetable waxes, e.g., carnauba wax, cotton wax, Japan wax and rice wax; animal waxes, e.g., bees wax and lanolin; mineral waxes, e.g., ozokelite and ceresine; and petroleum waxes, e.g., paraffin waxes, microcrystalline waxes and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes and ether waxes. In addition, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n-laurylmethacrylate and n-stearyl acrylate-ethyl methacrylate copolymers, can also be used.

Specific examples of the colorant for use in the present invention include any known dyes and pigments such as carbon black, Nigrosine dyes, black iron oxide, NAPHTHOL YELLOWS, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and their mixtures. The toner preferably include the colorant in an amount of from 1 to 15% by weight, and more preferably from 3 to 10% by weight.

The colorant for use in the present invention can be used as a masterbatch combined with a resin.

Specific examples of the resin for use in the masterbatch or for use in combination with masterbatch pigment include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The masterbatch for use in the toner of the present invention is typically prepared by mixing and kneading a resin and a colorant upon application of high shear stress thereto. In this case, an organic solvent can be used to heighten the interaction of the colorant with the resin. In addition, flushing methods in which an aqueous paste including a colorant is mixed with a resin solution of an organic solvent to transfer the colorant to the resin solution and then the aqueous liquid and organic solvent are separated and removed can be preferably used because the resultant wet cake of the colorant can be used as it is. Of course, a dry powder which is prepared by drying the wet cake can also be used as a colorant. In this case, a three-roll mill is preferably used for kneading the mixture upon application of high shear stress.

As an external additive to subsidize the fluidity, developability and chargeability of the toner of the present invention, a particulate inorganic material is preferably used. The particulate inorganic material preferably has an average primary particle diameter of from 5 nm to 2 μm, and more preferably from 5 to 500 nm. In addition, the particulate inorganic material preferably has a specific surface area of from 20 to 500 m²/g when measured by a BET method. The toner preferably includes the particulate inorganic material in an amount of from 0.01 to 5% by weight, and more preferably from 0.01 to 2.0% by weight. Specific examples of the particulate inorganic material include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

Among these particulate inorganic materials, a combination of a hydrophobic silica and a hydrophobic titanium oxide is preferably used as a fluidity improver. In particular, when a hydrophobic silica and a hydrophobic titanium oxide each having an average particle diameter not greater than 50 nm are used as an external additive, the electrostatic force and van der Waals' force between the external additive and the toner particles are improved, and thereby the resultant toner composition has a proper charge quantity. In addition, even when the toner composition is agitated in a developing device, the external additive is hardly released from the toner particles, and thereby image defects such as white spots and image omissions are hardly produced. Further, the quantity of particles of the toner composition remaining on image bearing members can be reduced.

When particulate titanium oxides are used as an external additive, the resultant toner composition can stably produce toner images having a proper image density even when environmental conditions are changed. However, the charge rising properties of the resultant toner tend to deteriorate. Therefore the addition quantity of a particulate titanium oxide is preferably smaller than that of a particulate silica, and in addition the total addition amount thereof is preferably from 0.3 to 1.5% by weight based on weight of the toner particles not to deteriorate the charge rising properties and to stably produce good images.

The toner of the present invention can be prepared by the following method, but the method is not limited thereto.

The aqueous medium for use in the present invention includes water alone and mixtures of water with a solvent which can be mixed with water. Specific examples of the solvent include alcohols such as methanol, isopropanol and ethylene glycol; dimethylformamide; tetra hydrofuran; cellosolves such as methyl cellosolve; and lower ketones such as acetone and methyl ethyl ketone.

The toner of the present invention can be prepared by reacting a dispersion formed of the prepolymer (A) having an isocyanate group with (B). As a method of stably preparing a dispersion formed of the urea-modified polyester or the prepolymer (A) in an aqueous medium, a method of including toner constituents such as the urea-modified polyester or the prepolymer (A) into an aqueous medium and dispersing them upon application of shear stress is preferably used. The prepolymer (A) and other toner constituents such as colorants, master batch pigments, release agents, charge controlling agents, unmodified polyester resins, etc. may be added into an aqueous medium at the same time when the dispersion is prepared. However, it is preferable that the toner constituents are previously mixed and then the mixed toner constituents are added to the aqueous liquid at the same time. In addition, colorants, release agents, charge controlling agents, etc., are not necessarily added to the aqueous dispersion before particles are formed, and may be added thereto after particles are prepared in the aqueous medium. A method of dyeing particles previously formed without a colorant by a known dying method can also be used.

The dispersion method is not particularly limited, and low speed shearing methods, high-speed shearing methods, friction methods, high-pressure jet methods, ultrasonic methods, etc. can be used. Among these methods, high-speed shearing methods are preferably used because particles having a particle diameter of from 2 to 20 μm can be easily prepared. At this point, the particle diameter (2 to 20 μm) means a particle diameter of particles including a liquid). When a high-speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure), and preferably from 40 to 98° C. When the temperature is relatively high, the urea-modified polyester or prepolymer (A) can easily be dispersed because the dispersion formed thereof has a low viscosity.

The content of the aqueous medium to 100 parts by weight of the toner constituents including the urea-modified polyester or prepolymer (A) is typically from 50 to 2,000 parts by weight, and preferably from 100 to 1,000 parts by weight. When the content is less than 50 parts by weight, the dispersion of the toner constituents in the aqueous medium is not satisfactory, and thereby the resultant parent toner particles do not have a desired particle diameter. In contrast, when the content is greater than 2,000, the production cost increases. A dispersant can preferably be used to prepare a stably dispersed dispersion including particles having a sharp particle diameter distribution.

Specific examples of the dispersants used to emulsify and disperse an oil phase for a liquid including water in which the toner constituents are dispersed include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can prepare a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4)sulfonate, sodium-{omega-fluoroalkanoyl(C6-C8)-N-ethylamino}-1-propane sulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of the marketed products of such surfactants having a fluoroalkyl group include SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOPEF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants, which can disperse an oil phase including toner constituents in water, include primary, secondary and tertiary aliphatic amines having a fluoroalkyl group, aliphatic quaternary ammonium salts such as erfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SURFLONS-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

In addition, inorganic compound dispersants such as tricalcium phosphate, calcium carbonate, titanium oxide, colloidal silica and hydroxyapatite which are hardly insoluble in water can also be used.

In addition, particulate polymers can also be used as a dispersant as well as inorganic dispersants such as calcium phosphate, sodium carbonate and sodium sulfate. Specific examples of the particulate polymers include particulate polymethyl methacrylate having a particle diameter of 1 μm and 3 μm, particulate polystyrene having a particle diameter of 0.5 μm and 2 μm, particulate styrene-acrylonitrile copolymers having a particle diameter of 1 μm, PB-200H (from Kao Corp.), SGP (Soken Chemical & Engineering Co., Ltd.), TECHNOPOLYMER SB (Sekisui Plastics Co., Ltd.), SPG-3G (Soken Chemical & Engineering Co., Ltd.), and MICROPEARL (Sekisui Fine Chemical Co., Ltd.).

Further, it is possible to stably disperse toner constituents in water using a polymeric protection colloid in combination with the inorganic dispersants and/or particulate polymers mentioned above. Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g., acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid. Further, in order to decrease viscosity of a dispersion medium including the toner constituents, a solvent which can dissolve the UMPE or prepolymer (A) can be used because the resultant particles have a sharp particle diameter distribution. The solvent is preferably volatile and has a boiling point lower than 100° C. because of easily removed from the dispersion after the particles are formed. Specific examples of such a solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination. Among these solvents, aromatic solvents such as toluene and xylene; and halogenated hydrocarbons such as methylene chloride, 1,2-dichloroethane, chloroform, and carbon tetrachloride are preferably used. The addition quantity of such a solvent is from 0 to 300 parts by weight, preferably from 0 to 100, and more preferably from 25 to 70 parts by weight, per 100 parts by weight of the prepolymer (A) used. When such a solvent is used to prepare a particle dispersion, the solvent is removed therefrom under a normal or reduced pressure after the particles are subjected to an elongation reaction and/or a crosslinking reaction of the modified polyester (prepolymer) with amine.

The elongation and/or crosslinking reaction time depend on reactivity of an isocyanate structure of the prepolymer (A) and amine (B), but is typically from 10 min to 40 hrs, and preferably from 2 to 24 hrs. The reaction temperature is typically from 0 to 150° C., and preferably from 40 to 98° C. In addition, a known catalyst such as dibutyltinlaurate and dioctyltinlaurate can be used.

In the present invention, a solvent is preferably removed from the dispersion liquid after the elongation and/or crosslinking reaction at 10 to 50° C. after it is strongly stirred at a specific temperature lower than the glass transition temperature of the resin and an organic solvent concentration to form and see particles, which deforms the toner. On the other hand, a ratio (Dv/Dn) between a volume-average particle diameter (Dv) and a number-average particle diameter (Dn) of the toner can be fixed by controlling a water layer viscosity, an oil layer viscosity, properties of resin particles, addition quantity thereof, etc. In addition, Dv and Dn can be fixed by controlling the properties of resin particles, addition quantity thereof, etc.

The toner of the present invention can be used for a two-component developer in which the toner is mixed with a magnetic carrier. A content of the toner is preferably from 1 to 10 parts by weight per 100 parts by weight of the carrier. Suitable carriers for use in the two component developer include known carrier materials such as iron powders, ferrite powders, magnetite powders, magnetic resin carriers, which have a particle diameter of from about 20 to 200 μm. A surface of the carrier may be coated by a resin. Specific examples of such resins to be coated on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetra fluoroethylene, vinylidenefluoride and other monomers including no fluorine atom, and silicone resins. An electroconductive powder may optionally be included in the toner. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The toner of the present invention can also be used as a one-component magnetic developer or a one-component non-magnetic developer.

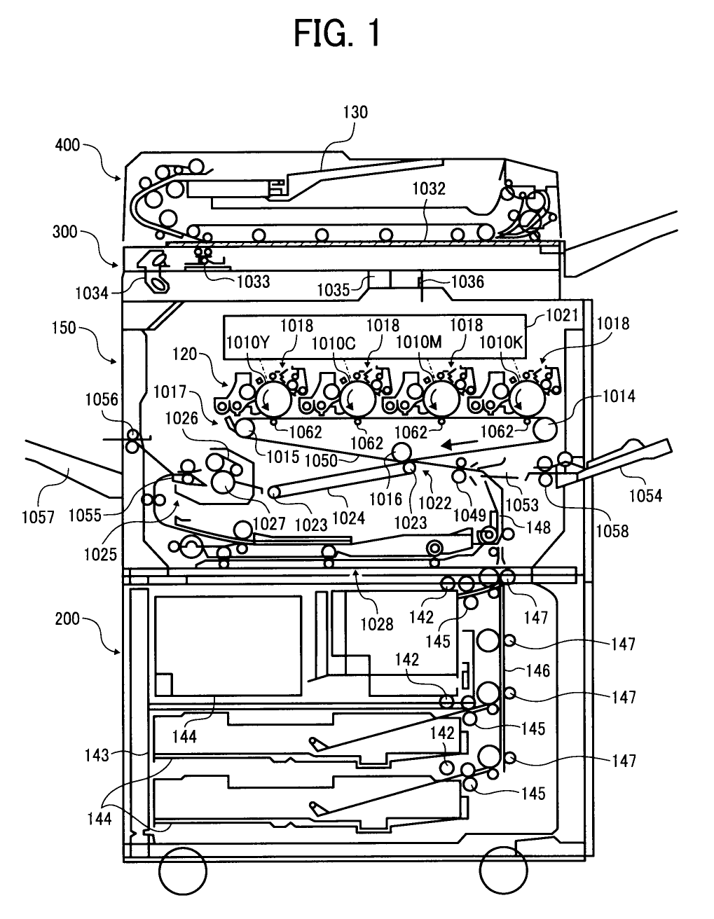

FIG. 1 is across-sectional view illustrating an embodiment of the image forming apparatus of the present invention. The image forming apparatus therein is a tandem full-color image forming apparatus, including a duplicator 150, a paper feeding table 200, a scanner 300 and an automatic document feeder (ADF) 400.

The duplicator 150 includes an intermediate transferee 1050 having the shape of an endless belt at the center. The intermediate transferee 1050 is suspended by three suspension rollers 1014, 1015 and 1016 and rotatable in a clockwise direction. On the left of the suspension roller 1015, an intermediate transferer cleaner 1017 is located to remove a residual toner on an intermediate transferer 1050 after an image is transferred. Above the intermediate transferer 1050, four image forming units 1018 for yellow, cyan, magenta and black colors are located in line from left to right along a transport direction of the intermediate transferer 1050 to form a tandem image forming developer 120. Above the tandem color image developer 120, an irradiator 1021 is located. On the opposite side of the tandem color image developer 120 across the intermediate transferee 1050, a second transferer 1022 is located. The second transferer 1022 includes a an endless second transfer belt 1024 and two rollers 23 suspending the endless second transfer belt 1024, and is pressed against the suspension roller 1016 across the intermediate transferer 1050 and transfers an image thereon onto a sheet. Beside the second transferer 1022, a fixer 1025 fixing a transferred image on the sheet is located. The fixer 1025 includes an endless fixing belt 1026 and a pressure roller 1027 pressing the fixing belt 1026.

Below the second transferer 1022 and the fixer 1025, a sheet reverser 1028 reversing the sheet to form an image on both sides thereof is located in the tandem color image forming apparatus.

Next, full-color image formation using a tandem image developer 120 will be explained. An original is set on a table 130 of the ADF 400 to make a copy, or on a contact glass 1032 of the scanner 300 and pressed with the ADF 400.

When a start switch (not shown) is put on, a first scanner 1033 and a second scanner 1034 scan the original after the original set on the table 130 of the ADF 400 is fed onto the contact glass 1032 of the scanner 300, or immediately when the original set thereon. The first scanner 1033 emits light to the original and reflects reflected light therefrom to the second scanner 1034. The second scanner further reflects the reflected light to a reading sensor 1036 through an imaging lens 1035 to read the color original (color image) as image information of black, yellow, magenta and cyan.

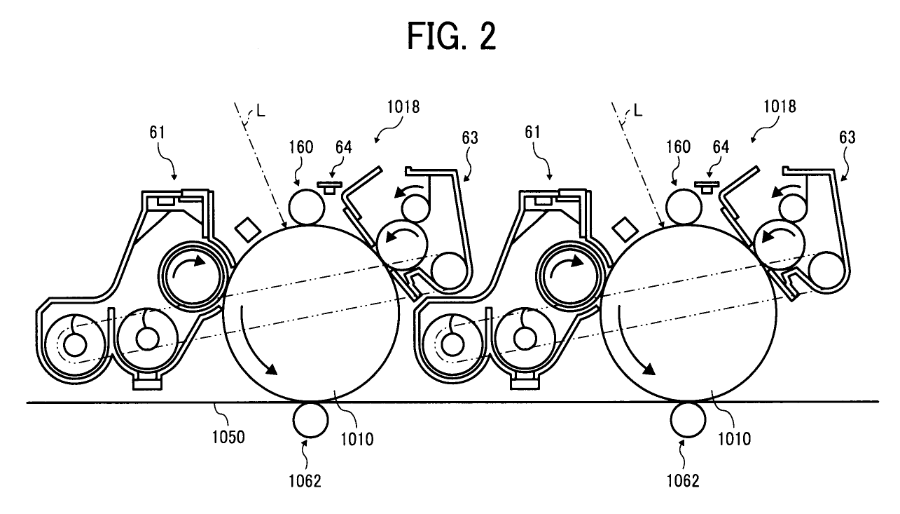

The black, yellow, magenta and cyan image information are transmitted to each image forming units 1018, i.e., a black image forming unit, a yellow image forming unit, a magenta image forming unit and a cyan image forming unit in the tandem image developer 120 respectively, and the respective image forming units form a black toner image, a yellow toner image, a magenta toner image and a cyan toner image. Namely, each of the image forming units 1018 in the tandem image developer 120 includes, as shown in FIG. 26, a photoreceptor 1110, i.e., a photoreceptor for black 1010K, a photoreceptor for yellow 1010Y, a photoreceptor for magenta 1010M and a photoreceptor for cyan 1010C; a charger 60 uniformly charging the photoreceptor; an irradiator irradiating the photoreceptor with imagewise light (L in FIG. 2) based on each color image information to form an electrostatic latent image thereon; an image developer 61 developing the electrostatic latent image with each color toner, i.e., a black toner, a yellow toner, a magenta toner and a cyan toner to form a toner image thereon; a transfer charger 1062 transferring the toner image onto an intermediate transferer 1050; a photoreceptor cleaner 63; and a discharger 64. When a start switch (not shown) is put on, a drive motor (not shown) rotates one of the suspension rollers 1014, 1015 and 1016 such that the other two rollers are driven to rotate, to rotate the intermediate transferee 1050. At the same time, each of the image forming units 1018 rotates the photoreceptor 1110 and forms a single-colored image, i.e., a black image (K), a yellow image (Y), a magenta image (M) and cyan image (C) on each photoreceptor 1010K, 1010Y, 1010M and 1010C. The single-colored images are sequentially transferred (first transfer) onto the intermediate transferer 1050 to form a full-color image thereon.

On the other hand, when start switch (not shown) is put on, one of paper feeding rollers 142 of paper feeding table 200 is selectively rotated to take a sheet out of one of multiple-stage paper cassettes 144 in a paper bank 143. A separation roller 145 separates sheets one by one and feed the sheet into a paper feeding route 146, and a feeding roller 147 feeds the sheet into a paper feeding route 148 to be stopped against a registration roller 1049. Alternatively, a paper feeding roller 142 is rotated to take a sheet out of a manual feeding tray 1054, and a separation roller 1058 separates sheets one by one and feed the sheet into a paper feeding route 1053 to be stopped against the registration roller 1049. The registration roller 1049 is typically earthed, and may be biased to remove a paper dust from the sheet. Then, in timing with a synthesized full-color image on the intermediate transferer 1050, the registration roller 1049 is rotated to feed the sheet between the intermediate transferer 1050 and the second transferer 1022, and the second transferer transfers (second transfer) the full-color image onto the sheet. The intermediate transferer 1050 after transferring an image is cleaned by the intermediate transferer cleaner 1017 to remove a residual toner thereon after the image is transferred.

The sheet the full-color image is transferred on is fed by the second transferer 1022 to the fixer 1025. The fixer 1025 fixes the image thereon upon application of heat and pressure, and the sheet is discharged by a discharge roller 1056 onto a catch tray 1057 through a switch-over click 1055. Alternatively, the switch-over click 1055 feeds the sheet into the sheet reverser 28 reversing the sheet to a transfer position again to form an image on the backside of the sheet, and then the sheet is discharged by the discharge roller 1056 onto the catch tray 1057.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

229 parts of an adduct of bisphenol A with 2 moles of ethyleneoxide, 529 parts of an adduct of bisphenol A with 3 moles of propyleneoxide, 208 parts terephthalic acid, 46 parts of adipic acid and 2 parts of dibutyltin oxide were polycondensated in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs, 44 parts of trimellitic acid anhydride were added thereto and the mixture was reacted for 2 hrs at a normal pressure and 180° C. to prepare an unmodified polyester resin.

The unmodified polyester resin had a number-average molecular weight of 2,500, a weight-average molecular weight of 6,700, a Tg of 43° C. and an acid value of 25 mg KOH/g.

1,200 parts of water, 540 parts of carbon black Printex 35 from Degussa A.G. having a DBP oil absorption of 42 ml/100 mg and a pH of 9.5, 1,200 parts of the unmodified polyester resin were mixed by a Henschel Mixer from Mitsui Mining Co., Ltd. After the mixture was kneaded by a two-roll mill having a surface temperature of 150° C. for 30 min, the mixture was extended by applying pressure, cooled and pulverized by a pulverizer from Hosokawa Micron Limited to prepare a masterbatch 1.

378 parts of the unmodified polyester resin, 110 parts of carnauba wax and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the masterbatch K and 500 parts of ethyl acetate were added to the mixture and mixed for 1 hr to prepare a material solution.

1,324 parts of the material solution were transferred into another vessel, and the carbon black and carnauba wax therein were dispersed by a beads mill (Ultra Visco Mill from IMECS CO., LTD.) for 3 passes at a liquid feeding speed of 1 kg/hr and a peripheral disc speed of 6 m/sec using zirconia beads having diameter of 0.5 mm for 80% by volume to prepare a wax dispersion 1.

Next, 1,324 parts of an ethyl acetate solution of the unmodified polyester resin having a concentration of 65% were added to the wax dispersion. 3.0 parts of Clayton APA from Southern Clay Products, Inc. were added as a charge controlling agent to 200 parts of the wax dispersion subjected to one pass using the Ultra Visco Mill under the same conditions to prepare a mixture. The mixture was stirred at 7,000 rpm for 30 min with T.K. Homodisper from Tokushu Kika Kogyo Co., Ltd. to prepare a toner constituents dispersion 1.

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltin oxide were mixed and reacted in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs to prepare an intermediate polyester resin.

The intermediate polyester resin had a number-average molecular weight of 2,100, a weight-average molecular weight of 9,500, a Tg of 55° C. and an acid value of 0.5 mg KOH/g and a hydroxyl value of 51 mg KOH/g.

Next, 410 parts of the intermediate polyester resin, 89 parts of isophoronediisocyanate and 500 parts of ethyl acetate were reacted in a reactor vessel including a cooling pipe, a stirrer and a nitrogen inlet pipe for 5 hrs at 100° C. to prepare a prepolymer. The prepolymer included a free isocyanate in an amount of 1.53% by weight.

170 parts of isophoronediamine and 75 parts of methyl ethyl ketone were reacted at 50° C. for 5 hrs in a reaction vessel including a stirrer and a thermometer to prepare a ketimine compound. The ketimine compound had an amine value of 418 mg KOH/g.

749 parts of the toner constituents dispersion 1, 115 parts of the prepolymer and 2.5 parts of the ketimine compound were mixed in a vessel by a T.K. Homomixer from Tokushu Kika Kogyo Co., Ltd. at 5,000 rpm for 1 min to prepare an oil phase mixed liquid 1.

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of an aqueous solution of persulfate ammonium having a concentration of 1% were added thereto and the mixture was reacted for 5 hrs at 75° C. to prepare a particulate resin dispersion.

The volume-average particle diameter of the particulate resin included in particulate resin dispersion was 105 nm when measured by MICROTRAC ultra fine particle diameter distribution measurer UPA-EX150 using laser Doppler method from Nikkiso Co., Ltd. In addition, the particulate resin dispersion was partly dried to isolate the resin, and the resin had a glass transition temperature of 59° C. and weight-average molecular weight of 150,000.

990 parts of water, 83 parts of the [particulate dispersion liquid], 37 parts of an aqueous solution of sodium dodecyldiphenyletherdisulfonate having a concentration of 48.5% (ELEMINOL MON-7 from Sanyo Chemical Industries, Ltd.), 135 parts of an aqueous solution having a concentration of 1% by weight of a polymer dispersant carboxymethylcellulose sodium Selogen BS-H-3 from DAI-ICHI KOGYO SEIYAKU CO., LTD. and 90 parts of ethyl acetate were mixed and stirred to prepare an aqueous medium 1.

0.8 parts of the tertiary amine compound having the formula (I) were mixed with 1,200 parts of the aqueous medium 1 by T.K. Homomixer at 5,000 rpm for 5 min to prepare a mixture. Further, 866.5 parts of the oil phase mixed liquid 1 were mixed with the mixture by T.K. Homomixer at 13,000 rpm for 20 min to prepare an emulsified slurry 1.

The emulsified slurry 1 was placed in a vessel including a stirrer and a thermometer, and after a solvent was removed therefrom at 30° C. for 8 hrs, the slurry was aged at 45° C. for 4 hrs to prepare a dispersion slurry.

The dispersion slurry had a volume-average particle diameter of 5.1 μm and a number-average particle diameter of 4.5 μm when measured by Multisizer III from Beckman Coulter. Inc.

After 100 parts of the dispersion slurry was filtered under reduced pressure, 100 parts of ion-exchange water were added to the filtered cake and mixed by T.K. Homomixer at 12,000 rpm for 10 min, and the mixture was filtered.

A phosphoric acid including phosphorus in an amount of 10% by weight were added to the filtered cake to have a pH of 3.7 and mixed by T.K. Homomixer at 12,000 rpm for 10 min, and the mixture was filtered.

Further, 300 parts of ion-exchange water were added to the filtered cake and mixed by T.K. Homomixer at 12,000 rpm for 10 min, and the mixture was filtered. This operation was repeated again to prepare a final filtered cake.

The final filtered cake was dried by an air drier at 45° C. for 48 hrs, and sieved with a mesh having an opening of 75 μm to prepare parent toner particles 1.

Then, 1.0 part of hydrophobic silica and 0.5 parts of hydrophobized titanium oxide were mixed with 100 parts of the parent toner particles by Henschel Mixer from Mitsui Mining Co. to prepare a toner 1.

### Preparations for the Following Examples and Comparative Examples

### Preparation of Toner Constituents Liquid 2

Next, 1,324 parts of an ethyl acetate solution of the unmodified polyester resin having a concentration of 65% were added to the wax dispersion. 4.5 parts of Clayton APA from Southern Clay Products, Inc. were added as a charge controlling agent to 200 parts of the wax dispersion subjected to one pass using the Ultra Visco Mill under the same conditions to prepare a mixture. The mixture was stirred for 30 min with T.K. Homodisper from Tokushu Kika Kogyo Co., Ltd. to prepare a toner constituents dispersion 2.

### (Preparation of Oil Phase Mixed Liquid 2)

749 parts of the toner constituents dispersion 1, 115 parts of the prepolymer and 2.5 parts of the ketimine compound were mixed in a vessel by a T.K. Homomixer from Tokushu Kika Kogyo Co., Ltd. at 5,000 rpm for 1 min to prepare an oil phase mixed liquid 2.

### (Preparation of Emulsified Slurry 2)

0.6 parts of the tertiary amine compound having the formula (I) were mixed with 1,200 parts of the aqueous medium 1 by T.K. Homomixer at 5,000 rpm for 5 min to prepare a mixture. Further, 866.5 parts of the oil phase mixed liquid 1 were mixed with the mixture by T.K. Homomixer at 13,000 rpm for 20 min to prepare an emulsified slurry 2.

### (Preparation of Emulsified Slurry 3)

0.3 parts of the tertiary amine compound having the formula (I) were mixed with 1,200 parts of the aqueous medium 1 by T.K. Homomixer at 5,000 rpm for 5 min to prepare a mixture. Further, 866.5 parts of the oil phase mixed liquid 1 were mixed with the mixture by T.K. Homomixer at 13,000 rpm for 20 min to prepare an emulsified slurry 3.

### (Preparation of Emulsified Slurry 4)

0.8 parts of a tertiary amine compound (triethanolamine from Wako Pure Chemical Industries, Ltd.) were mixed with 1,200 parts of the aqueous medium 1 by T.K. Homomixer at 5,000 rpm for 5 min to prepare a mixture. Further, 866.5 parts of the oil phase mixed liquid 1 were mixed with the mixture by T.K. Homomixer at 13,000 rpm for 20 min to prepare an emulsified slurry 4.

### (Preparation of Emulsified Slurry 5)

0.6 parts of the tertiary amine compound having the formula (I) were mixed with 1,200 parts of the aqueous medium 1 by T.K. Homomixer at 5,000 rpm for 5 min to prepare a mixture. Further, 866.5 parts of the oil phase mixed liquid 2 were mixed with the mixture by T.K. Homomixer at 13,000 rpm for 20 min to prepare an emulsified slurry 5.

### (Preparation of Emulsified Slurry 6)

866.5 parts of the oil phase mixed liquid 1 were mixed with 1,200 parts of the aqueous medium 1 by T.K. Homomixer at 13,000 rpm for 20 min to prepare an emulsified slurry 6.

### (Preparation of Emulsified Slurry 7)

866.5 parts of the oil phase mixed liquid 2 were mixed with 1,200 parts of the aqueous medium 1 by T.K. Homomixer at 13,000 rpm for 20 min to prepare an emulsified slurry 7.

### Example 2

The procedure for preparation of toner 1 in Example 1 was repeated except for replacing the emulsified slurry 1 with the emulsified slurry 2 to prepare a toner 2.

### Example 3

The procedure for preparation of toner 1 in Example 1 was repeated except for replacing the emulsified slurry 1 with the emulsified slurry 3 to prepare a toner 3.

### Example 4

The procedure for preparation of toner 1 in Example 1 was repeated except for replacing the emulsified slurry 1 with the emulsified slurry 4 to prepare a toner 4.

### Example 5

The procedure for preparation of toner 1 in Example 1 was repeated except for replacing the emulsified slurry 1 with the emulsified slurry 5 to prepare a toner 5.

### Comparative Example 1

The procedure for preparation of toner 1 in Example 1 was repeated except for replacing the emulsified slurry 1 with the emulsified slurry 6 to prepare a toner 6.

### Comparative Example 1

The procedure for preparation of toner 1 in Example 1 was repeated except for replacing the emulsified slurry 1 with the emulsified slurry 6 to prepare a toner 6.

### Comparative Example 2

The procedure for preparation of toner 1 in Example 1 was repeated except for replacing the emulsified slurry 1 with the emulsified slurry 7 to prepare a toner 7.

The properties of the toners 1 to 7 and evaluation results thereof are shown in Tables 1 and 2, respectively.

(Image density) [ID]

After 150,000 images of an image chart having an image area of 50% were produced in a monochrome mode by a digital full-color copier imagio Color 2800 from Ricoh Company, Ltd., a solid image was produced on a Ricoh 6000 paper from Ricoh Company, Ltd., and the image density was measured by X-Rite from X-Rite, Inc. 4 colors were independently produced and an average of their image densities was determined.

⊚: 1.8 to less than 2.2

◯: 1.4 to less than 1.8

Δ: 1.2 to less than 1.4

X: less than 1.2

### (Image Granularity and Sharpness) [IG]

Mono-color images were produced by a digital full-color copier imagio Color 2800 from Ricoh Company, Ltd., and visually observed to evaluate the image granularity and sharpness. ⊚ was as good as an offset printing, ◯ was slightly worse than the offset printing, Δ was considerably worse than the offset printing and X was very poor.

### (Chargeability)

9 g of a carrier and 1 g of each toner were stirred in a cylindrical stainless pot having a length of 30 mm and a diameter of 30 mm at 600 rpm to prepare a developer.

The chargeabilities of 1 g of the developer after stirred for 60 sec [60], 10 min [10] and 24 hrs [24] were measured by a blowoff apparatus from Toshiba Chemical Co., Ltd. Further, after the measurement, the blown carrier was collected again and mixed with a new toner for 10 min, and the chargeability of the mixture was measured.

The chargeability after stirred for 60 sec is a standard of charge build ability, and preferably almost equal to that after stirred for 10 min.

The charge abilities after stirred for 10 min and 24 hrs need to be flat. The chargeability after stirred for 24 hrs lower than that after stirred for 10 min causes toner spent and charge leakage.

### (Foggy Image) [FI]

After 100,000 images 5% were continuously produced by iPSio Color 8100 from Ricoh Company, Ltd., the image density of the following image was measured to evaluate the toner contamination thereon. ⊚ means that no toner contamination was observed, ◯ means a slight contamination without problems, Δ means a contamination was observed and X means an unacceptable contamination with serious problems.

### (Fixability)

iPSio Color 8100 from Ricoh Company, Ltd. Ricoh Company, Ltd. modified to produce a solid toner image including a toner of 1.00±0.1 mg/cm². A temperature at which offset does not occur on TYPE 6200 paper from Ricoh Company, Ltd. was determined as a maximum fixable temperature.

The fixing roll temperature at which a fixed image had an image density not less than 70% after scraped with a pad was determined as the minimum fixable temperature [MFT]. In addition, the low-temperature fixability was evaluated based on the following standard.

⊚: lower than 140° C.,

◯: not higher than 140° C.

Δ: higher than 140° C. and lower than 150° C.

X: not lower than 150° C.

Fixing width [FW] not less than 50° C. was ◯, greater than 40° C. and less than 50° C. was Δ, and not greater than 40° C. was X.

TABLE 1

| | | | | Average |
|---|---|---|---|---|
| | Toner | Dv | Dv/Dn | circularity |
| Example 1 | Toner 1 | 4.8 | 1.14 | 0.99 |
| Example 2 | Toner 2 | 5.1 | 1.13 | 0.98 |
| Example 3 | Toner 3 | 6.2 | 1.18 | 0.97 |
| Example 4 | Toner 4 | 6.0 | 1.22 | 0.99 |
| Example 5 | Toner 5 | 5.7 | 1.21 | 0.96 |
| Comparative | Toner 6 | 5.5 | 1.16 | 0.95 |
| Example 1 | | | | |
| Comparative | Toner 7 | 6.2 | 1.24 | 0.93 |
| Example 2 | | | | |

TABLE 2

| | ID | IG | FI | MFT | FW | 60 | 10 | 24 | OA |
|---|---|---|---|---|---|---|---|---|---|
| Example 1 | ⊚ | ⊚ | ⊚ | ⊚ | ◯ | −19 | −17 | −17 | ◯ |
| Example 2 | ⊚ | ⊚ | ⊚ | ⊚ | ◯ | −25 | −24 | −23 | ◯ |
| Example 3 | ⊚ | ⊚ | ⊚ | ◯ | ◯ | −28 | −27 | −27 | ◯ |
| Example 4 | ⊚ | ⊚ | ◯ | ◯ | ◯ | −24 | −24 | −22 | ◯ |
| Example 5 | ⊚ | ◯ | ⊚ | ◯ | ◯ | −30 | −28 | −26 | ◯ |
| Comparative | ◯ | X | Δ | ◯ | Δ | −29 | −19 | −14 | X |
| Example 1 | | | | | | | | | |
| Comparative | X | X | X | Δ | Δ | −38 | −24 | −16 | X |
| Example 2 | | | | | | | | | |

*OA: Overall Evaluation

### Example 6

749 parts of the toner constituents dispersion 1, 115 parts of the prepolymer and 2.2 parts of the ketimine compound were mixed in a vessel by a T.K. Homomixer from Tokushu Kika Kogyo Co., Ltd. at 5,000 rpm for 1 min to prepare an oil phase mixed liquid 3.

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of an aqueous solution of persulfate ammonium having a concentration of 1% were added thereto and the mixture was reacted for 5 hrs at 75° C. to prepare a particulate resin dispersion.

The volume-average particle diameter of the particulate resin included in particulate resin dispersion was 105 nm when measured by MICROTRAC ultra fine particle diameter distribution measurer UPA-EX150 using laser Doppler method from Nikkiso Co., Ltd. In addition, the particulate resin dispersion was partly dried to isolate the resin, and the resin had a glass transition temperature of 59° C. and weight-average molecular weight of 150,000.

990 parts of water, 83 parts of the [particulate dispersion liquid], 37 parts of an aqueous solution of sodium dodecyldiphenyletherdisulfonate having a concentration of 48.5% (ELEMINOL MON-7 from Sanyo Chemical Industries, Ltd.), 135 parts of an aqueous solution having a concentration of 1% by weight of a polymer dispersant carboxymethylcellulose sodium Selogen BS-H-3 from DAI-ICHI KOGYO SEIYAKU CO., LTD. and 90 parts of ethyl acetate were mixed and stirred to prepare an aqueous medium 1.

866.5 parts of the oil phase mixed liquid 3 were mixed with 1,200 parts of the aqueous medium 1 by T.K. Homomixer at 11,000 rpm for 20 min to prepare an emulsified slurry 8.

The emulsified slurry 8 was placed in a vessel including a stirrer and a thermometer, and after a solvent was removed therefrom at 30° C. for 8 hrs, the slurry was aged at 45° C. for 4 hrs to prepare a dispersion slurry.

After 100 parts of the dispersion slurry was filtered under reduced pressure, 100 parts of ion-exchange water were added to the filtered cake and mixed by T.K. Homomixer at 12,000 rpm for 10 min, and the mixture was filtered.

A phosphoric acid including phosphorus in an amount of 10% by weight were added to the filtered cake to have a pH of 3.7 and mixed by T.K. Homomixer at 12,000 rpm for 10 min, and the mixture was filtered.

Further, 300 parts of ion-exchange water were added to the filtered cake and mixed by T.K. Homomixer at 12,000 rpm for 10 min, and the mixture was filtered. This operation was repeated again to prepare a final filtered cake.

The final filtered cake was dried by an air drier at 45° C. for 48 hrs, and sieved with a mesh having an opening of 75 μm to prepare parent toner particles 8.

Then, 1.0 part of hydrophobic silica and 0.5 parts of hydrophobized titanium oxide were mixed with 100 parts of the parent toner particles by Henschel Mixer from Mitsui Mining Co. to prepare a toner 8.

### Preparations for the Following Examples and Comparative Examples

### Preparation of Aqueous Medium 2

3 parts of the tertiary amine compound having the formula (I) were mixed with 1,200 parts of the aqueous medium 1 by T.K. Homomixer at 5,000 rpm for 5 min to prepare an aqueous medium 2.

### (Preparation of Oil Phase Mixed Liquid 4)

749 parts of the toner constituents dispersion 2, 115 parts of the prepolymer and 2.2 parts of the ketimine compound were mixed in a vessel by a T.K. Homomixer from Tokushu Kika Kogyo Co., Ltd. at 5,000 rpm for 1 min to prepare an oil phase mixed liquid 4.

### (Preparation of Aqueous Medium 3)

5 parts of the tertiary amine compound having the formula (I) were mixed with 1,200 parts of the aqueous medium 1 by T.K. Homomixer at 5,000 rpm for 5 min to prepare an aqueous medium 3.

### (Preparation of Emulsified Slurry 9)

866.5 parts of the oil phase mixed liquid 3 were mixed with 1,200 parts of the aqueous medium 3 by T.K. Homomixer at 11,000 rpm for 20 min to prepare an emulsified slurry 9.

### (Preparation of Aqueous Medium 4)

1 part of the tertiary amine compound having the formula (I) were mixed with 1,200 parts of the aqueous medium 1 by T.K. Homomixer at 5,000 rpm for 5 min to prepare an aqueous medium 4.

### (Preparation of Emulsified Slurry 10)

866.5 parts of the oil phase mixed liquid 3 were mixed with 1,200 parts of the aqueous medium 4 by T.K. Homomixer at 11,000 rpm for 20 min to prepare an emulsified slurry 10.

### (Preparation of Emulsified Slurry 11)

866.5 parts of the oil phase mixed liquid 4 were mixed with 1,200 parts of the aqueous medium 3 by T.K. Homomixer at 11,000 rpm for 20 min to prepare an emulsified slurry 11.

### (Preparation of Emulsified Slurry 12)

866.5 parts of the oil phase mixed liquid 3 were mixed with 1,200 parts of the aqueous medium 1 by T.K. Homomixer at 11,000 rpm for 20 min to prepare an emulsified slurry 12.

### (Preparation of Aqueous Medium 5)

10 parts of the tertiary amine compound having the formula (I) were mixed with 1,200 parts of the aqueous medium 1 by T.K. Homomixer at 5,000 rpm for 5 min to prepare an aqueous medium 5.

### Example 7

The procedure for preparation of toner 8 in Example 6 was repeated except for replacing the emulsified slurry 8 with the emulsified slurry 9 to prepare a toner 9.

### Example 8

The procedure for preparation of toner 8 in Example 6 was repeated except for replacing the emulsified slurry 8 with the emulsified slurry 10 to prepare a toner 10.

### Example 9

The procedure for preparation of toner 8 in Example 6 was repeated except for replacing the emulsified slurry 8 with the emulsified slurry 11 to prepare a toner 11.

### Comparative Example 3

The procedure for preparation of toner 8 in Example 6 was repeated except for replacing the emulsified slurry 8 with the emulsified slurry 12 to prepare a toner 12.

### Comparative Example 4

The procedure for preparation of toner 8 in Example 6 was repeated except for replacing the emulsified slurry 8 with the emulsified slurry 13 to prepare a toner 13.

The properties of the toners 8 to 13 and evaluation results thereof are shown in Tables 1 and 2, respectively.

### (Image Density) [ID]

After 150,000 images of an image chart having an image area of 50% were produced in a monochrome mode by a digital full-color copier imagio Color 2800 from Ricoh Company, Ltd., a solid image was produced on a Ricoh 6000 paper from Ricoh Company, Ltd., and the image density was measured by X-Rite from X-Rite, Inc. 4 colors were independently produced and an average of their image densities was determined.

⊚: 1.8 to less than 2.2

◯: 1.4 to less than 1.8

Δ: 1.2 to less than 1.4

X: less than 1.2

### (Image Granularity and Sharpness) [IG]

Mono-color images were produced by a digital full-color copier imagio Color 2800 from Ricoh Company, Ltd., and visually observed to evaluate the image granularity and sharpness. ⊚ was as good as an offset printing, ◯ was slightly worse than the offset printing, Δ was considerably worse than the offset printing and X was very poor.

### (Chargeability)

9 g of a carrier and 1 g of each toner were stirred in a cylindrical stainless pot having a length of 30 mm and a diameter of 30 mm at 600 rpm to prepare a developer.

The chargeabilities of 1 g of the developer after stirred for 60 sec [60], 10 min [10] and 24 hrs [24] were measured by a blowoff apparatus from Toshiba Chemical Co., Ltd. Further, after the measurement, the blown carrier was collected again and mixed with a new toner for 10 min, and the chargeability of the mixture was measured.

The chargeability after stirred for 60 sec is a standard of charge buildability, and preferably almost equal to that after stirred for 10 min.

The chargeabilities after stirred for 10 min and 24 hrs need to be flat. The chargeability after stirred for 24 hrs lower than that after stirred for 10 min causes toner spent and charge leakage.

### (Foggy Image) [FI]

After 100,000 images 5% were continuously produced by iPSio Color 8100 from Ricoh Company, Ltd., the image density of the following image was measured to evaluate the toner contamination thereon. ⊚ means that no toner contamination was observed, ◯ means a slight contamination without problems, Δ means a contamination was observed and X means an unacceptable contamination with serious problems.

### (Fixability)

iPSio Color 8100 from Ricoh Company, Ltd. Ricoh Company, Ltd. modified to produce a solid toner image including a toner of 1.0±0.1 mg/cm². A temperature at which offset does not occur on TYPE 6200 paper from Ricoh Company, Ltd. was determined as a maximum fixable temperature.

The fixing roll temperature at which a fixed image had an image density not less than 70% after scraped with a pad was determined as the minimum fixable temperature [MFT]. In addition, the low-temperature fixability was evaluated based on the following standard.

⊚: lower than 140° C.

◯: not higher than 140° C.

Δ: higher than 140° C. and lower than 150° C.

X: not lower than 150° C.

Fixing width [FW] not less than 50° C. was ◯, greater than 40° C. and less than 50° C. was Δ, and not greater than 40° C. was X.

TABLE 1

| | | | | Average | pH of Aqueous |
|---|---|---|---|---|---|
| | Toner | Dv | Dv/Dn | circularity | Medium |
| Example 6 | Toner 8 | 5.3 | 1.15 | 0.97 | 7.0 |
| Example 7 | Toner 9 | 4.8 | 1.13 | 0.99 | 7.5 |
| Example 8 | Toner 10 | 6.2 | 1.18 | 0.96 | 6.6 |
| Example 9 | Toner 11 | 5.4 | 1.20 | 0.98 | 7.5 |
| Comparative | Toner 12 | 5.5 | 1.17 | 0.95 | 5.9 |
| Example 3 | | | | | |
| Comparative | Toner 13 | 6.6 | 1.30 | 0.99 | 8.3 |
| Example 4 | | | | | |

TABLE 2

| | ID | IG | FI | MFT | FW | 60 | 10 | 24 | OA |
|---|---|---|---|---|---|---|---|---|---|
| Example 6 | ⊚ | ⊚ | ⊚ | ⊚ | ◯ | −25 | −23 | −23 | ◯ |
| Example 7 | ⊚ | ⊚ | ◯ | ◯ | ◯ | −19 | −18 | −17 | ◯ |
| Example 8 | ⊚ | ⊚ | ⊚ | ⊚ | ◯ | −28 | −27 | −27 | ◯ |
| Example 9 | ⊚ | ⊚ | ◯ | ◯ | ◯ | −30 | −27 | −26 | ◯ |
| Comparative | ◯ | X | Δ | ◯ | Δ | −29 | −20 | −14 | X |
| Example 3 | | | | | | | | | |
| Comparative | X | X | X | Δ | Δ | −38 | −24 | −16 | X |
| Example 4 | | | | | | | | | |

*OA: Overall Evaluation

This application claims priority and contains subject matter related to Japanese Patent Application No. 2008-045704, filed on Feb. 27, 2008, the entire contents of which are hereby incorporated by reference.

Having now fully described the invention, it will be apparent to one of ordinary skill in the art that many changes and modifications can be made thereto without departing from the spirit and scope of the invention as set forth therein.

1. A toner prepared by a method comprising:
dissolving or dispersing at least:
at least one member selected from the group consisting of binder resins and precursors thereof,
a colorant,
a release agent, and
a layered inorganic mineral in which ions between its layers are at least partially modified with an organic ion in an organic solvent to prepare a solution or a dispersion which is an oil phase; and
dispersing the oil phase in an aqueous medium to prepare an emulsified dispersion in which parent toner particles are granulated,
wherein the aqueous medium comprises a tertiary amine compound.

2. The toner of claim 1, wherein the tertiary amine compound has the following formula (I):

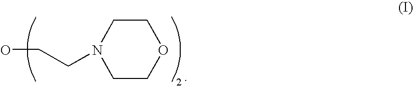

3. The toner of claim 1, wherein the aqueous medium has a pH of from 6.5 to 8.0.

4. The toner of claim 1, wherein the organic ion is an organic cation.

5. The toner of claim 1, wherein the oil phase comprises a solid content comprising the layered inorganic mineral in an amount of from 0.1 to 5% by weight.

6. The toner of claim 1, wherein the oil phase comprises a binder resin precursor comprising a modified polyester resin and a compound elongatable or crosslinkable with the binder resin precursor; and the aqueous medium comprises a particulate material dispersant, wherein the binder resin precursor is subjected to at least one of an elongation reaction and a crosslinking reaction in the emulsified dispersion and the organic solvent is removed therefrom.

7. The toner of claim 1, wherein the binder resin is a polyester resin.

8. The toner of claim 1, wherein the toner has an average circularity of from 0.96 to 0.99.

9. The toner of claim 1, wherein the toner has a volume-average particle diameter of from 3 to 7 μm.

10. The toner of claim 1, wherein the toner has a ratio (Dv/Dn) of the volume-average particle diameter (Dv) thereof to a number-average particle diameter (Dn) thereof not greater than 1.30.

11. The toner of claim 1, wherein the toner comprises particles having a particle diameter not greater than 2 μm in an amount of from 1 to 20% by number.

12. The toner of claim 1, wherein the binder resin comprises the polyester resin in an amount of from 50 to 100% by weight.

13. The toner of claim 1, wherein the polyester resin comprises tetra hydrofuran-insoluble components having a weight-average molecular weight of from 1,000 to 30,000.

14. The toner of claim 1, wherein the binder resin has an acid value of from 1.0 to 50.0 (KOH mg/g).

15. The toner of claim 1, wherein the binder resin has a glass transition temperature of from 35 to 65° C.

16. The toner of claim 1, wherein the binder resin precursor has a site reactable with a compound having an active hydrogen group and a polymeric weight-average molecular weight of from 3,000 to 20,000.

17. The toner of claim 1, wherein the toner has an acid value of from 0.5 to 40.0 (KOH mg/g).

18. The toner of claim 1, wherein the toner has a glass transition temperature of from 40 to 70° C.

19. The toner of claim 1, wherein the toner is comprised in a two-component developer.

20. A developer comprising the toner according to claim 1.
